(19) United States
(12) Patent Application Publication
(10) Pub. No.: US 2007/0230227 A1
(43) Pub. Date: Oct. 4, 2007

(54) Universal Power Adapter

(76) Inventor: Douglas A. Palmer, San Diego, CA (US)

Correspondence Address: WHYTE HIRSCHBOECK DUDEK S C, 555 EAST WELLS STREET, SUITE 1900, MILWAUKEE, WI, 53202, US

(21) Appl. No.: 11/568,205

(22) PCT Filed: Apr. 29, 2005
(86) PCT No.: PCT/US05/15075

§ 371 Date: Oct. 23, 2006

Related U.S. Application Data
(60) Provisional application No. 60/566,383, filed on Apr. 29, 2004.

(51) Int. Cl. H02M 1/00; H02M 7/00

(52) U.S. Cl. 363/78; 363/13

(57) ABSTRACT

A power adapter device and a power delivery system are disclosed herein. The power adapter device includes an input terminal at which the device receives input power having an input power characteristic, and an output terminal at which the device provides output power having an output power characteristic, where the device is further able to receive an informational signal via the output terminal. Additionally the power adapter device includes a conversion device coupled between the input terminal and the output terminal that is capable of converting at least a portion of the input power having the input power characteristic into the output power having the output power characteristic, and a processing device coupled to the conversion device, where the processing device controls the conversion device based at least in part upon the informational signal so that the output characteristic of the output power satisfies a requirement specified by the signal.

### CROSS-REFERENCE TO RELATED APPLICATIONS

This application claims the benefit of U.S. provisional patent application No. 60/566,383 entitled “Universal Power Adapter” filed on Apr. 29, 2004, which is hereby incorporated by reference herein.

### STATEMENT REGARDING FEDERALLY SPONSORED RESEARCH OR DEVELOPMENT

### Field of the Invention

The present invention relates to electrical power conversion devices and, more particularly, to electrical power conversion devices capable of providing variable levels of power to different loads that have different power requirements.

### BACKGROUND OF THE INVENTION

The electrical power delivery system within the United States and many foreign countries has evolved into a mature, standardized form. Power is generated at power plants of various types, communicated from those power plants via a power grid by way of high voltage lines to locations throughout the country, and then stepped down to lower voltage levels (e.g., 120 volts AC in the United States and 240 volts AC in many foreign countries) for use in homes and businesses and at other locations (e.g., ships, automobiles, stadia, kitchen/office/bath locations, airplanes, military/tactical situations, hotels, workshops, etc.). The voltage, current, frequency and other characteristics of the power delivered by this system to end users, as well as the overall level of power delivered, is satisfactory for supplying the power needs of a variety of different consumer and commercial applications, including a variety of consumer appliances that require moderately high levels of power such as washers and dryers, ovens and various motorized equipment.

Nevertheless, with the development of numerous low-power consumer appliances including audiovisual devices and photographic equipment, as well as the development of primarily low-power computerized and wireless devices particularly with the advent of the Internet) and their increasing importance to residential consumers and businesses alike, the characteristics and levels of power provided by the standard power delivery system are not as well suited to the needs of residential consumers, businesses and other consumers as in the past. In particular, the standardized power delivery system makes available relatively high levels of power that, without modification, are unsuitable for these low-power devices.

To allow for the standard power delivery system to provide power to these various devices, various power adapters have been developed and implemented so that the devices can receive power that suits their needs. Typically these power adapters take the form of “black boxes” that are configured to plug into wall sockets/outlets and convert the standard power from the wall outlets into power having the characteristics/levels that are appropriate for the devices requiring power.

While the use of these various power adapters with low-power devices successfully serves the purpose of enabling these devices to obtain appropriate power from the standard power delivery system, the use of such adapters is far from ideal. Because different low-power devices have different power requirements in terms of power type (e.g., DC or AC), voltage level, current level, frequency, phase, and a variety of other characteristics, as well as in terms of short-term peak power requirements, long-term overall power requirements, and other power level issues, any given adapter designed for use with any particular low-power device is typically inapplicable for use with practically any other device. Consequently, myriad different adapters are necessary for use with the myriad different low-power devices, and consumers must make sure that they purchase, properly implement and avoid misplacing the respective adapter that is appropriate for each particular device.

The use of these many different types of adapters is inefficient, wasteful and otherwise disadvantageous on several counts. Typically, whenever a device is replaced with a new or upgraded model, the adapter associated with the old device is no longer applicable and consequently is discarded even though the adapter is still capable of functioning properly. Further, the use of these conventional adapters increases the costs of the various devices with which the adapters are associated. Primary beneficiaries of the present system (if any) may be the manufacturers of replacement adapters, who often can charge high prices for specialized and, in some cases, proprietary adapters because consumers are often willing to pay for such adapters rather than purchase entirely new low-power devices to replace the low-power devices with which the adapters are associated.

An additional problem associated with the use of these power adapters is that the power adapters, while often fairly efficient in terms of their power conversion capabilities, nevertheless still dissipate a large amount of heat. While some inefficiency may always be present in any given power adapter, the use of conventional power adapters is often particularly inefficient insofar as the adapters typically remain plugged into wall outlets and remain on (or at least in a “standby” mode) even when the low-power devices to which they are coupled do not require power. Consequently, significant power is dissipated and wasted.

The increasing incompatibility between the power delivered to homes, businesses and other locations by the standard power delivery system on the one hand, and the power needs of residential consumers, businesses, and other consumers on the other hand, is likely to continue in the future. The number of low-voltage devices already greatly exceeds the number of 120 volt AC devices in the home. As wireless devices and computerized devices continue to be used with even greater frequency, and particularly when lighting devices transition from light bulbs to low-power lighting devices such as light emitting diodes (LEDs), there will be only a few devices left in homes and businesses that still might be suited to receive power in the form that it is currently delivered to homes and businesses.

As the power needs of consumer devices, commercial devices and other devices are increasingly diverging from the power characteristics and power levels provided by the standard power delivery system, changes in technology are also enabling the creation of new power source devices that, while capable of generating useful amounts of power, nevertheless often provide power having characteristics/levels that are also incompatible with the power characteristics/levels of the standard power delivery system. Such power generating devices, for example, devices that transform naturally-occurring energy such as solar energy and wind energy into electrical energy, often are incompatible with the standard power delivery system and again require specialized adapter devices to conform their power output characteristics with those of the standard power delivery system.

Further, the use of rechargeable batteries and similar energy storage elements in a variety of low-power and other devices continues to increase. Although the energy stored in such batteries/storage elements sometimes is exhaustively utilized, it is nevertheless commonly the case that the energy stored in such devices in the end is not put to good use but rather is simply wasted (e.g., by throwing out the batteries). In the aggregate, a significant amount of energy is being wasted because it cannot be readily provided onto the standard power delivery system/power grid, or otherwise used in a convenient manner for other applications.

Additionally, while adapters allowing for the conversion of power from the standard power delivery system into power satisfying the requirements of low-power devices are the most common types of adapters currently available, these adapters only constitute a large portion of the overall number of adapters that are required by residential consumers, businesses and other consumers. That is, in certain environments, the power that is readily available has characteristics/levels that are different from the power provided by the standard power delivery system. In such environments, the power adapters that are appropriate differ from those employed in relation to the standard power delivery system.

Automobiles in particular commonly employ electrical power systems that are capable of providing power with different characteristics/levels than that of the standard power delivery system. Consequently, consumers wishing to “plug in” certain devices with respect to their automobiles power systems require additional specialized adapters than those appropriate for interfacing the standard power delivery system. As automotive manufacturers move towards 42 volt power systems, additional adapters will be required.

Conventional power adapters of the types discussed above typically are not variable in terms of the power that the adapters output (or, more particularly, are not variable in terms of one or more characteristics of the power being output, e.g., a voltage level), and also are not variable in terms of the power conversion processes that the adapters perform. Nevertheless, there do exist conventional variable power conversion devices. However, such conventional variable power conversion devices are unlikely to solve the aforementioned problems associated with power adapters.

First, conventional variable power conversion devices typically only are capable of varying their power conversion processes in a limited number of manners to suit the power requirements of only a limited number of loads. Typically, such conversion devices are not designed to be able to receive power from a variety of different power sources or storage elements. Further, because of the limited capabilities of conventional variable power conversion devices, users who are employing such conversion devices must be knowledgeable about how to implement those devices so as to avoid improperly connecting those devices to loads or power sources.

Therefore, for the above reasons, it would be advantageous if an improved system could be developed that reduced the need for the myriad specialized power adapters that are currently used for providing power from the standard power delivery system (and other conventional power delivery systems) to various different electronic devices, particularly low-power devices. Further, it would be desirable if such a system was inexpensive to implement (or at least comparable in price) in comparison with utilizing conventional power adapters, as well as simple to implement and operate, and relatively simple and inexpensive to manufacture. Additionally, it would be advantageous if such a system could in some circumstances convert power not only between conventional power delivery systems such as the standardized power delivery system and various loads, but also between various alternate power sources/storage devices and various conventional power delivery systems and loads.

### BRIEF SUMMARY OF THE INVENTION

The present inventor has recognized that the above needs could be met with the development of a new, variable power adapter that in at least some embodiments would be capable of converting power from the standard power delivery system (as well as from other conventional power delivery systems such as those found in automobiles) into any of a variety of different powers having different characteristics and/or levels as required by a variety of different low-power devices or other devices. In certain embodiments, such a variable power adapter could further be capable of receiving power from a variety of power sources/storage devices and converting the received power, as appropriate, to arrive at power with characteristics and/or levels that could be delivered to different load devices and/or to other power systems such as the standard power delivery system itself.

Preferably, the new, variable power adapter in at least some embodiments would be capable not only of receiving and providing power having a variety of characteristics and levels, but also would have intelligence that allowed the adapter to automatically adjust its operation based upon the power characteristics/levels required by the loads to which the adapter was connected and/or the power characteristics/levels of the power sources/storage devices to which the adapter was connected. In some embodiments, the adapter would be configured to communicate with such load or source/storage device to allow for such automatic operational adjustment.

In particular, the present invention relates to a power adapter device. The power adapter device includes at least one terminal at which the power adapter device receives first input power having a first input power characteristic, and provides first output power having a first output power characteristic. The power adapter device further includes a conversion device coupled to the at least one terminal, where the conversion device is capable of converting at least a portion of the first input power having the first input power characteristic into at least a portion of the first output power having the first output power characteristic. The power adapter device additionally includes a processing device coupled to the conversion device, where the processing device controls the conversion device based upon at least one informational signal received from an external location.

The present invention further relates to a power adaptive device for use in relation to low-power devices. The power adaptive device includes a terminal having a plurality of ports, a control device and a conversion device coupled to the terminal and to the control device. The conversion device in at least some operational circumstances causes a plurality of different power types to be available for output at the plurality of ports, respectively.

Additionally, the present invention relates to a power delivery system. The power delivery system includes a first power adapter device that has a terminal capable of providing an output power, a variable conversion device coupled at least indirectly to the terminal, and a control device coupled to the conversion device. The power delivery system further includes a load device capable of receiving the output power. The type of output power provided to the load device depends upon at least one of an operational status of the variable conversion device based at least in part upon an informational signal received by the control device, and a physical configuration of at least one of the terminal and a corresponding connection element of the load device.

Also, the present invention relates to a power delivery system. The power delivery system includes a terminal capable of receiving an input power, a variable conversion device coupled at least indirectly to the terminal, and a control device coupled to the conversion device. The power delivery system additionally includes a source device capable of providing the input power. Further, at least one of the following is true: an operational status of the power adapter device is determined based upon an informational signal received by the control device; and a type of the input power received by the terminal is determined at least in part by a physical configuration of at least one of the terminal and a corresponding connection element of the source device.

Further, the present invention relates to a power system. The power system includes a plurality of power source devices respectively providing a plurality of different types of input powers, and a plurality of load devices respectively receiving a plurality of different types of output powers. The power system also includes a power adapter device coupled to at least four of the power source devices and the load devices, including at least two of the power source devices and at least two of the load devices. The power adapter device includes means for converting among the powers that are provided and received by the at least four devices.

Additionally, the present invention relates to a method of supplying power. The method includes providing a power adapter device having a variable conversion device, connecting an input port of the power adapter device to a first power supply, and coupling an output port of the power adapter device to a load. The method also includes receiving at least one informational signal from the load indicative of a power requirement of the load, and adjusting an operational status of the variable conversion device so as to provide, based upon an input power received from the first power supply, an output power of a type satisfying the power requirement.

### BRIEF DESCRIPTION OF THE DRAWINGS

FIG. 1 is a block diagram showing an exemplary power delivery system including an exemplary power adapter along with an exemplary consumer device that could interact with such power adapter, in accordance with one exemplary embodiment of the present invention; and

FIG. 2 is a block diagram showing an exemplary power conversion circuit that could be employed within the exemplary power adapter of FIG. 1.

### DETAILED DESCRIPTION OF THE PREFERRED EMBODIMENT

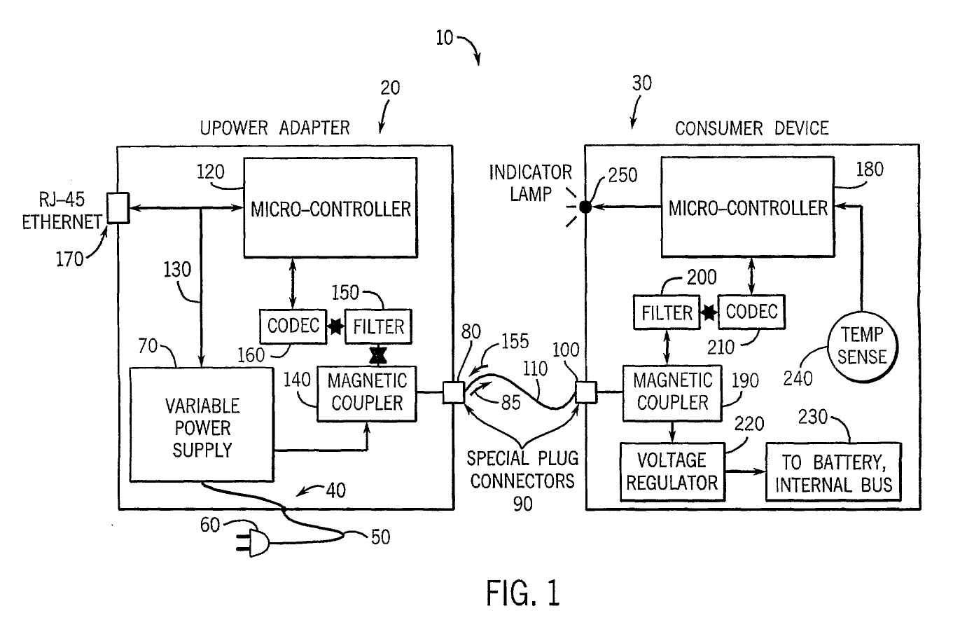

Referring to FIG. 1, a block diagram is provided showing an exemplary power delivery system 10 in accordance with one embodiment of the present invention. As shown, the power delivery system 10 includes a power adapter 20 and a power consumer or load device 30. The power adapter 20 includes an input terminal 40 that is adapted to be coupled to a power source (not shown).

The power source can be any of a variety of standard and specialized power sources. Typically, the power source is a standard power delivery system that provides power to wall sockets/outlets in homes or businesses or at other locations, and consequently the input terminal 40 is shown to include a cord 50 and a conventional plug 60 for interfacing such a wall outlet, allowing the input terminal 40 to be coupled to 120 volt AC (or, in the case of European outlets, 240 volt AC) power.

In other embodiments, the input terminal 40 also can be coupled to other conventional power delivery systems, such as the power outlet of an automobile (e.g., a 42 volt outlet). In still further embodiments, the input terminal 40 can be coupled to other specialized power sources such as solar power generators, wind power generators and internal combustion generators. Additionally, in some embodiments the input terminal 40 can be coupled to various batteries or other storage devices.

Although in some embodiments the power adapter 20 is configured so that the input terminal 40 is capable of being coupled only to one type of power source, in alternate embodiments the input terminal 40 is configured to be coupled to a wide variety of power sources having a wide variety of power characteristics/levels. Further, in certain embodiments the power adapter 20 is capable of simultaneously being coupled to more than one power source rather than merely a single power source.

As shown in FIG. 1, the power adapter 20 includes a variable power supply or variable power conversion device 70, which is coupled not only to the input terminal 40 but also to an output terminal 80 of the power adapter 20 (in the embodiment shown, the power conversion device is indirectly coupled to the output terminal 80 by way of a magnetic coupler discussed in further detail below). The variable power conversion device 70 is capable of converting input power received via the input terminal 40 into output power (shown as an arrow 85) provided at the output terminal 80.

As a variable power conversion device, the power conversion device 70 is capable of providing as the output power 85 at the output terminal 80 a wide variety of powers having a wide variety of power characteristics and power levels that are appropriate for a wide variety of different types of load devices such as the load device 30. In the present embodiment the power adapter 20 is capable of outputting a wide variety of powers at various low-power (and low-voltage) levels and having various related characteristics, such that a variety of low-power load devices and other low-power devices can be coupled to the power adapter 20 to receive power without the need for specialized adapters for each respective one of the load devices.

In particular, the output power 85 provided by the output terminal 80 can take on any of a variety of power levels and power characteristics including, for example, powers having a variety of different voltage levels, current levels, frequencies, phases, peak power values and average power values, durations, other timing characteristics, charge/discharge characteristics and other characteristics. While as mentioned above the present embodiment is particularly intended to provide power to a variety of different low-power devices, the present embodiment and/or alternate embodiments also are capable of providing power having a variety of desired characteristics/levels to medium or high-power devices.

As shown, in the present embodiment special plug connectors 90 exist at the output terminal 80 as well as at an input terminal 100 of the load device 30 to allow for power delivery from the power adapter 20 to the load device 30, as well as possibly in the opposite direction as well. In the embodiment shown, the plug connectors 90 are connected by way of an additional cord 110. The cord 110 is representative of a variety of different possible wire, bus, or other (even possibly wireless) linkages by which power could be delivered between the connectors 90. In some embodiments, the cord 110 could be a more complicated coupling device that allowed for the communication of power between not merely two connectors at two devices but rather allowed for the communication of power among more than two connectors at possibly more than two devices.

Further as shown in FIG. 1, the power adapter 20 includes a control or processing device 120 that provides control signals to the variable power conversion device 70 by way of one or more internal bus or other connections 130. The processing device 120 can take any of a variety of forms of control or processing devices known to those of ordinary skill in the art including, for example, one or more microprocessors, microcontrollers, programmable logic devices, hard-wired circuitry, discrete components, and other control circuits.

The processing device 120 is also in communication with the output terminal 80 by way of one or more coupling devices, one or more of which can themselves be included as part of the processing device 120 or alternately (as shown) be treated as separate devices outside the processing device. In the present embodiment, specifically, these coupling devices include a magnetic coupler 140 that is coupled directly to the output terminal 80, and a filter 150 that is coupled to the magnetic coupler, with the magnetic coupler being positioned between the output terminal and the filter. Additionally, a codec (coder/decoder) device 160 is coupled between the filter 150 and the processing device 120. As noted above, the magnetic coupler 140 also is what couples the variable power conversion device 70 to the output terminal 80.

Further, in certain embodiments, the processing device 120 is or can be in contact/communication with other devices external to the power adapter 20 by way of a variety of channels that can include, for example, the internet or another network such as an Ethernet network or a blue-tooth network. The power adapter 20 can be coupled to such other channel(s) by way of additional port(s), such as an Ethernet port 170 shown in FIG. 1. In some embodiments, the processing device 120 is in communication the load device 30 by way of such channel(s).

The magnetic coupler 140, the filter 150 and the codec device 160 can enable a variety of types of communication and/or control signals to be passed between the processing device 20 and the output terminal 80. In some embodiments, the magnetic coupler 140, filter 150 and codec device 160 are used to provide feedback to the processing device 20 concerning the output power 85 being supplied by the power conversion device 70. Further, in the present embodiment the magnetic coupler 140, filter 150 and codec device 160 in particular allow for informational signals 155 that are received by the output terminal 80 from the load device 30 to be recognized and processed by the processing device 120. The informational signals 155 provided by the load device 30 provide information regarding one or more power level or other power characteristic conditions that are desired or required the load device 30.

The informational signals 155 can take a variety of forms. For example, the informational signals 155 can be “strobed” signals that are automatically, periodically sent by the load device 30 to the adapter 20, or signals that are sent by the load device in response to specific inquiry signals sent by the adapter to the load device. Based upon the information supplied by the informational signals 155, the processing device 120 is able to determine the proper power conversion operation by the power conversion device 70 and provide appropriate control signals thereto via the connection(s) 130. That is, the processing device 120 controls operation of the power conversion device 70 based at least in part upon the informational signals 155 received from the load device 30, which can be communicated via connectors 90 and cord 110 or by some other communication linkage.

In alternate embodiments, the processing device 120 is able to determine the power requirements of the load device 30 in other ways rather than by receiving the informational signals 155 (or in addition to receiving those signals). For example, in some such embodiments, the processing device 120 is capable of performing tests upon the load device 30 by way of communication channels other than that created by the special connectors 90/cord 110 linking the output terminal 80 and input terminal 100. However, the present embodiment is preferred insofar as only one linkage between the power adapter 20 and the load device 30 is required in order for the power adapter to obtain all of the information that it needs in order to provide the appropriate output power 85 to the load device 30.

In order for the load device 30 to provide the informational signals 155, the load device in the present embodiment also includes certain internal components. In particular, as shown, the load device 30 includes its own controller or processing device 180 (which can take any of a variety of forms such as those discussed above with reference to the processing device 120) that is in communication with the input terminal 100 of the load device. As in the case of the processing device 120, the processing device 180 is coupled to the input terminal 100 by way of additional coupling devices that, in the embodiment shown, include a magnetic coupler 190, a filter 200, and a codec device 210.

As further shown, in the embodiment of FIG. 1, the magnetic coupler 190 is coupled between the input terminal 100 and the filter 200, the filter is coupled between the magnetic coupler and the codec device 210, and the codec device is coupled between the filter and the processing device 180. As in the case of the coupling devices of the power adapter 20, one or more of the magnetic coupler 190, filter 200, and codec device 210 could be included as part of the processing device 180 or, as shown, treated as separate devices. By virtue of the magnetic coupler 190, the filter 200 and codec device 210, the processing device 180 is able to communicate the informational signals 155 to the input terminal 100 and thus to the output terminal 80 of the power adapter 20.

Although the output power 85 provided to the input terminal 100 of the load device 30 is intended to have the proper power characteristics and to be of the proper power level so as to be appropriate for the load device 30, the load device 30 still can include its own power conversion device to further modify the received power so that it is suitable for internal use within the load device. Thus, as shown in FIG. 1, the load device 30 includes a voltage regulator 220 that is coupled between the input terminal 100 and those internal device(s) 230 within the load device that require power. Also as shown, the coupling of the voltage regulator 200 to the input terminal 100 is indirect, by way of the magnetic coupler 190, similar to the manner in which the variable power conversion device 70 of the power adapter is coupled to the output terminal 80.

FIG. 1 shows the internal devices 230 to include various devices that are coupled to an internal bus within the load device 30 including, for example, a battery of the load device. In this manner, the internal devices 230 are intended to be generally representative of any power consuming devices or energy storage devices, including any combination or multiplicity of such devices.

The processing device 180 typically is also configured to monitor the power received at the output terminal 100, by way of the magnetic coupler 190, the filter 200, and the codec device 210. In this manner, the processing device 180 makes sure that the power being received is appropriate for the load device 30. Further, the processing device 180 can receive and utilize additional information such as temperature information from a temperature sensor 240 within the load device.

Also, the processing device 180 can output information. The output information can take the form of external operator-observable indications such as that afforded by an indicator lamp 250. Also, while not shown, the processing device 180 in certain embodiments can also send output signals to other devices, for example, by way of a port such as the Ethernet port 170 of the power adapter 20. Although the voltage regulator 220 in the present embodiment is intended to be a device that is fixed in terms of its operation, in alternate embodiments, it also can be a variable power conversion device that is controlled, for example, by way of the processing device 180.

The variable power conversion device 70 of the power adapter 20 can take any of a variety of forms that allow for appropriate power conversion processes (including a variety of different processes) so as to provide power having the appropriate characteristics and levels as desired/required by any given load device such as the load device 30. Preferably, the power conversion device 70 is nearly unlimited in terms of its power conversion capabilities, such that the power adapter 20 can be universally (or almost universally) utilized as an adapter for converting one type of power into another type of power.

Although the embodiment of FIG. 1 envisions the power adapter 20 as receiving one specific type of power from one specific type of supply via the input terminal 40, the present invention is intended to encompass embodiments in which the power conversion device 70 is capable of receiving multiple different types of power having different power characteristics and/or power levels, and then converting those different types of power into a single desired type of power or a variety of different types of power with various different power characteristics and/or power levels. That is, the power adapter 20 can be variable not only in terms of the power it outputs but also in terms of the power it inputs.

In particular, in certain embodiments it is desirable that the power adapter 20 be capable of providing a wide variety of low-level powers for a wide variety of low-power devices. In this manner, through the use of one or more of such power adapters 20, a low-level power grid or “nano-grid” for low-power devices can be created that supplements the moderately-high-power standard power delivery system that is currently providing power to homes and businesses. In contrast to the standard power delivery system, such a nano-grid would allow for numerous different types of power with different characteristics/levels to be provided to the variety of different load devices that required those different types of power.

Further, by way of the processing device 120 as well as, depending upon the embodiment, communications between that processing device and other processing devices such as the processing device 180 of the load device 30, the power adapter 20 is capable of intelligently adapting its behavior to the needs of a particular load or loads. Additionally, where as discussed above the power adapter 20 is capable of receiving multiple types of power from a variety of different power sources rather than merely one type of power, the processing device 120 is able to similarly communicate with such power sources to determine the characteristics/levels of power being provided by those power sources (or able to otherwise sense or determine such information), so as to allow the power adapter to intelligently adjust its behavior based upon the power being provided by those power sources.

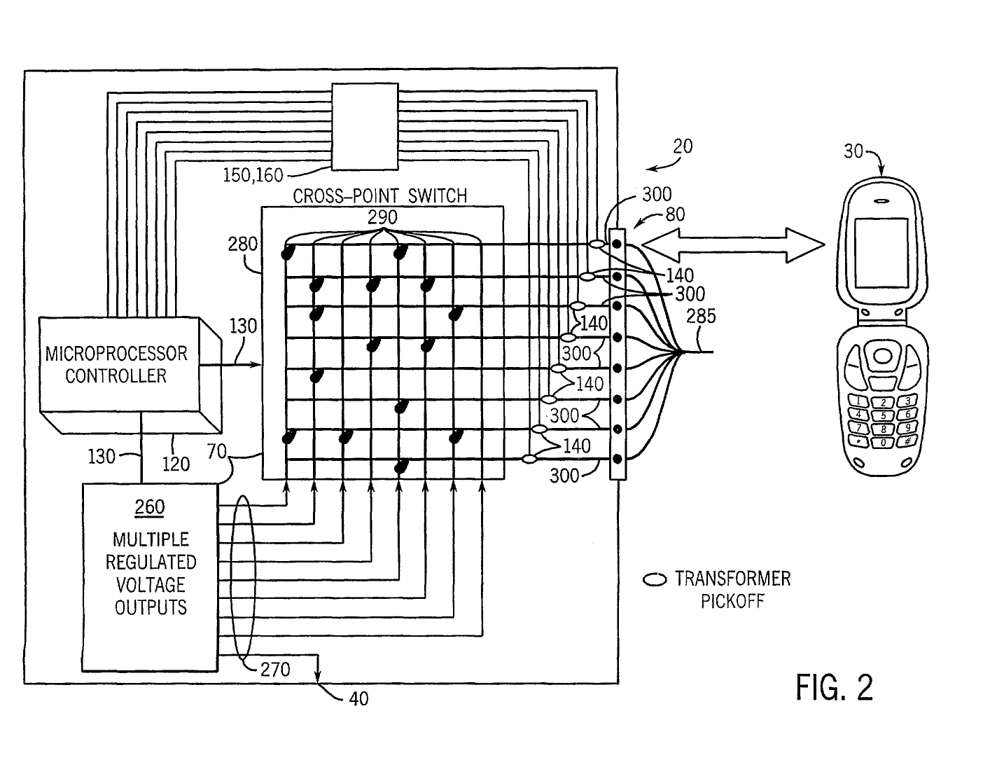

Turning to FIG. 2, one exemplary, specialized embodiment of the power adapter 20 is shown, albeit the power adapter 20 of FIG. 1 is not intended to be limited to the particular embodiment shown in FIG. 2. In the embodiment of FIG. 2, the variable power conversion device 70 includes a first voltage regulation unit 260 that is capable of receiving the input power from the input terminal 40 and creating, based upon that input power, multiple regulated voltage outputs 270. These multiple regulated voltage outputs 270 in turn are provided to a power cross-point switch 280, which also forms part of the power conversion device 70.

As shown, the cross-point switch 280 is essentially a matrix formed by a plurality of lines 290 respectively coupled to the outputs 270 that criss-cross a plurality of output lines 300 that are each coupled to the output terminal 80. Various connections between the lines 290 and 300 can be created and eliminated based upon control signals provided by the processing device 120, which is in communication with both the cross-point switch 280 and the voltage regulation device 260 by way of the communication links 130. In certain embodiments, the control signals activate or deactivate taps on a transformer. In this manner, the processing device 120 can control various power characteristics (e.g., voltage level) and/or power levels of the power being supplied by the output lines.

The various output lines 300 each have their own respective transformer pick off(s) that together form the magnetic coupler 140, which in turn is in communication with the processing device 120 by way of the filter 150 and codec device 160. The power provided by way of the output lines 300 at the output terminal 80 is in turn available for provision at eight output jacks or ports 285. This available power can in turn be communicated to the load device 30, which in the example shown at FIG. 2 is a cellular phone.

The output terminal 80 with its eight output ports 285 shown in FIG. 2 is one exemplary output terminal among many different possible output terminals, and so the output terminal 80 of FIG. 1 not should not be interpreted as being limited to that shown in FIG. 2. The output terminal 80 of FIG. 1 can in some embodiments be a single port device (for example, a two-lead port). Any given load device such as the load device 130 can be coupled to the single output terminal 80, and the power adapter 20 automatically adjusts the power at that single port so that it meets the needs of the load device. In other embodiments, the output terminal 80 would include multiple such ports, any one of which is capable of providing a variety of different powers to different load devices (even simultaneously).

In contrast, in embodiments such as that shown in FIG. 2, the output terminal 80 includes multiple ports such as the ports 285, each of which is capable of providing only a specific power type (having a specific power characteristic and/or level). That is, in embodiments employing the cross-point switch 280 shown in FIG. 2 or similar cross-point switches, the power adapter 20 is capable of providing multiple different power levels at the multiple different output ports 285 respectively corresponding to the output lines 300 that collectively form the overall output terminal 80.

The determination of which of the output ports 285 provide(s) power to the load device 30 in any given situation can be made by the load device, the power adapter 20, or both (or even could, in alternate embodiments, be made directly or indirectly by an additional external control system, entity or operator). Nevertheless, to the extent that multiple output power types having different power characteristics and/or power levels can be provided at different ports 285 of the output terminal 80, the power adapter 20 is capable in at least some embodiments of providing the desired power output to a given load device without as much information (or any information) being provided by way of informational signals such as the informational signals 155 from the load device 30.

In particular, by providing the multiple ports 285 offering power with different characteristics/levels at the output terminal 80, it is possible to provide different load devices such as the load device 30 with the power that the devices respectively require simply by coupling the respective load devices to the proper one (or more) of the ports of the output terminal 80. In some of these embodiments, in which the power output by the power adapter 20 is not substantially or at all adjusted based upon the informational signals 155, the load device 30 can have its own particular plug (or other mechanically-limiting element) that is configured to fit within a particular one or more of the ports 285 of the overall output terminal 80.

Alternatively, the load device 30 can have a special plug (not shown) that is configured to be mechanically coupled to the entire output terminal 80, but only electrically coupled to particular one(s) of the ports 285. In these manners, the appropriate power supplied to the load device 30 can be determined mechanically based upon the characteristics of the plug and the output terminal 80 rather than controlled by way of any of the processing devices 120,180, etc. In such embodiments, no informational signals such as the informational signals 155 need be provided from the load device as discussed with reference to FIG. 1.

Therefore, in certain embodiments the power adapter 20 is an “intelligent” device that is designed to adjust the particular output power that it provides based upon information received from the load device 30 or other information that can be deduced or determined regarding that load device and its power requirements. Yet in other, alternate, embodiments, the power adapter 20 simply offers multiple different types of power and is physically configured so as to be capable of connecting with multiple different load devices having different power requirements. In such embodiments, the appropriate power that is provided to any given load device is based upon the specific connection that is made between that load device and the power adapter. Power adapters in which the power delivered to load devices depends upon a combination of these factors are also possible.

Further, while the power adapter 20 of FIG. 2 employing the cross-point switch 280 has been described as having the single input terminal 40 and the multiple output ports 285 at the output terminal 80, depending upon the embodiment one or more of the multiple output ports 285 of the output terminal also (or instead) can function as an input port. Likewise, in some embodiments the input terminal 40 can function as an output terminal/port. Indeed, each of the terminals 40,80 in some embodiments can function in both a power-inputting and power-outputting capacity, and the present invention envisions embodiments in which there is complete generality of input/output function among the different input/output terminals/ports of the power adapter 20.

In particular, the cross-point switch 280 is a highly-flexible power conversion device that can operate in a variety of manners such that any given one of the output ports 285 of the power adapter is capable of being coupled to a power source as well as to a power load and thus capable of operating as an output port as well as an input port. Thus, the terms “output” and “input” used with respect to different terminals/ports/nodes shown on the cross-point switch 280 and the power adapter 20 of FIGS. 1 and 2, and particularly the term “output” used with respect to the output ports 285, are employed as a matter of convenience herein to describe certain embodiments of power adapters employing cross-point switches in which certain terminals are designated specifically to be coupled to power sources or to power loads.

Thus, while the present invention is intended to encompass embodiments in which specific terminals/ports of the power adapter are designated for and limited to one type of input or output function, the present invention is also intended to encompass embodiments in which any one or more of the terminals/ports of the power adapter can be coupled by users, either indiscriminately or under certain operational circumstances, to power load(s) or to power source(s) to receive input power or to provide output power in a bidirectional manner. Also, the present invention is intended to encompass embodiments in which a power adapter has certain terminals/ports that are designated as input or output terminals/ports, and other terminals/ports that are capable of being utilized as both input and output terminals/ports depending upon operational circumstances.

Generally, the present invention is intended to encompass embodiments in which a power adapter is capable of receiving a single type of power and converting that power into one or more different power types with different power levels and/or different power characteristics. Likewise, the present invention is intended to encompass embodiments in which a power adapter is capable of converting a multiplicity of different power types with different power levels and/or characteristics into a single power type. Further, the present invention is intended to encompass embodiments in which a power adapter is capable of converting a multiplicity of different power types into another multiplicity of different power types.

To the extent that, in some of these embodiments, a power adapter is configured for operation in conjunction with a variety of different power sources and/or storage devices so as to receive or input power, the power adapter not only can take the form shown in FIG. 2 (where one or more of the ports 285 of the cross-point switch 280 are configured to receive rather than output power) but also can take many other forms. For example, in some embodiments, not only the power adapter but also the power source or storage device can have a processing device analogous to the processing device 180 of the load device 30, and the power adapter can adjust its behavior based upon informational signals analogous to the informational signals 155 provided between the load device and the power adapter of FIG. 1.

Indeed, the power adapters 20 shown in FIGS. 1 and 2 and particularly the power adapter with the cross-point switch 280 shown in FIG. 2 are only examples of a multiplicity of different configurations that are possible for power adapters encompassed by the present invention in terms of the power conversion device(s) and other circuitry/structures employed therewithin. In alternate embodiments, for example, the power adapter can include any of a number of different power conversion devices including, for example, boost converters, buck converters, buck-boost converters, Cuk converters, AC to AC converters (transformers), chopper circuits including thyristor chopper circuits, inverters, rectifiers, and bucket brigade devices (BBDs), which can be large-scale BBDs.

Such various power conversion devices can be implemented by way of a variety of different technologies such as semiconductor technologies employing various transistors such as field effect transistors (FETs) and bipolar junction transistors (BJTs), some of which can be implemented in a solid-state, monolithic manner. Where large-scale BBDs are employed, several of such devices can be integrated on a single monolithic circuit. Such BBDs can be used to move charges to the ports 285, for example. In certain embodiments, the output power from the power adapter 20 includes an output voltage and an output current that can be adjusted by a frequency and an amount of charge injected into a first bucket of the BBD, such that the conversion device operates as a charge coupled device (CCD). Taps on the BBD allow for picking off varying voltages from the BBD.

Further, the present invention is intended to encompass embodiments in which the power adapter is capable, via any one or more of its terminals/ports, of operating as a communication router for a variety of communication signals being provided between and among power sources, power loads and/or other devices coupled at those terminals. Such communication signals can include not merely informational signals concerning power requirements such as the informational signals 155 discussed above, but also can generally include any signals providing other types of information as well.

In preferred embodiments, the power adapter 20 is capable of being used as a single power supply device to power any of a variety of mobile devices, fixed devices and power packs. The informational signals for communicating power parameter information, such as the informational signals 155 in FIG. 1, are low-data rate communications (e.g., using RS485 equivalent Ethernet packets). Other communications, such as that over the Internet or other networks (e.g., by way of the Ethernet port 170) can be high-data rate communications (e.g., 10 MB/sec).

In certain embodiments, communications could occur in three modalities, namely, power communications relating to power requests and status, low-speed communications and high-speed communications. Although communications can occur by way of any of a variety of different protocols and standards, in one embodiment, the IEEE 802.3x communications standard is employed. Communications could also occur by way of various conventional busses such as USB, VME, and P1394 busses. In some embodiments, general data packet switching and communications with the load device (or other devices) are also possible.

Also, in preferred embodiments, the power adapter 20 can be used in a variety of ways to perform a variety of functions along the lines of those discussed above as well in addition to those discussed above. For example, the power adapter 20 can act as a power sink for cycling batteries. Also, the power adapter can have precautionary features such as a spike protection feature and an over-temperature shut down feature, such that the power adapter takes special action or shuts down when excessively high power spikes or high temperatures occur. The power adapter can act as a bridge to, from and between a variety of different conventional power delivery systems. The power adapter can operate as a power sink for cycling batteries.

In addition to contributing to overall energy efficiency by allowing alternate energy sources such as solar power sources to be used and improving battery life (particularly insofar as it is not necessary for a user to find a particular adapter to recharge batteries whenever batteries need recharging), the adapter also has energy-saving modes of operation of its own, including a stand-by mode, an idle mode, and high-power modes, such that excessive power waste does not occur, and also requires minimal quiescent boot power. Not only is the power adapter able to accept and convert power from power sources but also it is able to yield and transfer electrical power of a variety of levels and characteristics to other devices, and in certain circumstances can be operated to prioritize the provision of electrical power to different devices.

Because in certain embodiments the power adapter 20 is capable of receiving power having a variety of different characteristics and levels, the power adapter in such embodiments can be used by a consumer to drain power within one device and provide it to another device that needs power. Also, in some embodiments, the power adapter 20 automatically shuts down whenever the consumer device 30 to which it is connected is disconnected. Also, in certain embodiments, further specialized adapter plugs can be used to allow the output terminal 80 of the power adapter 20 (as well as any corresponding input terminal such as the input terminal 40) to allow the power adapter 20 to interface older generation devices.

Indeed, given that the power adapter 20 in many embodiments employs the processing device 120 or similar control elements, the power adapter can be programmed to operate in a number of manners depending upon various circumstances. For example, the power adapter could preferentially select that power be input from one power source (e.g., an environmentally-friendly power sources such as a solar cell) over another power source. Likewise, where the power adapter is providing power from one or more sources to one or more loads, the power adapter could prioritize where power is distributed. Further, in certain embodiments the power adapter 20 is capable of retaining quiescent power to power up at least one control device (e.g., the processing device 120) within the power adapter.

The present invention is intended to be capable of being used to provide power to a wide variety of devices requiring a variety of power types having a variety of power characteristics and levels. In particular, the present invention is applicable to a variety of low-voltage or moderate-voltage devices including, for example (but not limited to), personal digital assistance (PDAs), cell phones, shavers, tools, laptops, speakers, camcorders, cameras, battery packs/chargers, various appliances, soldering stations, hair-care devices, LED lighting, digital clocks/clock radios, televisions, VCRs, compact and rack audios, microwave ovens, regular and cordless telephones, answering machines, flat-screen devices, low-volt halogen lights, boom boxes, power tools, sensors, hedge trimmers, clocks, door locks, timers, military man-packs, medical equipment, toys, land warrior man-packs (e.g., military accessories used by soldiers) and a variety of other devices.

Also, for example, the adapter is also capable of providing power having a variety of voltages including, for example, 1.5 volts, 3.4 volts, 5.6 volts, 6.7 volts, 7.5 volts, 9.0 volts, 12.0 volts and 24.0 volts, each of which respectively could be output at one of the output ports 285 shown in FIG. 2. Also, in some embodiments, the adapter is capable of providing AC or DC power and, in the case of AC power, is capable of providing power at 50 Hz, 60 Hz and other frequencies (e.g., up to 50 KHz). In further embodiments, the adapter can provide trickle power and also can provide a variety of current levels as well as limit the current output provided. In still additional embodiments, the adapter can have open input and output terminals, and/or can provide power having class 2 features such as under 30 volts of output, with AC input in isolation.

It is specifically intended that the present invention not be limited to the embodiments and illustrations contained herein, but include modified forms of those embodiments including portions of the embodiments and combinations of elements of different embodiments as come within the scope of the following claims.

We claim:

1. A power adapter device comprising:
at least one terminal at which the power adapter device receives first input power having a first input power characteristic, and provides first output power having a first output power characteristic;
a conversion device coupled to the at least one terminal, wherein the conversion device is capable of converting at least a portion of the first input power having the first input power characteristic into at least a portion of the first output power having the first output power characteristic; and
a processing device coupled to the conversion device, wherein the processing device controls the conversion device based upon at least one informational signal received from an external location.

2. The power adapter device of claim 1, wherein the informational signal is received from a load device that is coupled to the at least one terminal to receive the output power therefrom.

3. The power adapter device of claim 2, wherein the informational signal concerns a required power characteristic of the load device, wherein the required power characteristic is at least one of a required power level and another power characteristic selected from the group consisting of a voltage characteristic, a current characteristic, a peak power characteristic, an average power characteristic, a frequency characteristic, a phase characteristic, a waveform characteristic, a duration characteristic, and a timing characteristic.

4. The power adapter device of claim 3, wherein the at least one terminal includes an input terminal and an output terminal, wherein the output power is at least one of DC power and AC power, wherein the informational signal is received from the load device via the output terminal, and wherein the input power is received at the input terminal from a standardized power delivery system.

5. The power adapter device of claim 1, wherein the at least one terminal includes a terminal via which both input power and output power can be conveyed in a bidirectional manner.

6. The power adapter device of claim 1, wherein the at least one terminal includes an input terminal and an output terminal, and wherein the output terminal includes a plurality of ports at which a plurality of different output powers in addition to the first output power can be provided, wherein the plurality of different output powers have a plurality of different output power characteristics.

7. The power adapter device of claim 1, wherein the at least one terminal includes an input terminal and an output terminal, wherein the input terminal is capable of receiving a plurality of different input powers in addition to the first input power, and wherein the plurality of different input powers have a plurality of different input power characteristics.

8. The power adapter device of claim 7, wherein the output terminal includes a plurality of ports at which a plurality of different output powers in addition to the first output power can be provided, wherein the plurality of different output powers have a plurality of different output power characteristics, whereby the power adapter device is capable of converting the input powers into the output powers.

9. The power adapter device of claim 1, wherein the conversion device includes at least one of a cross-point switch, a buck converter, a boost converter, a buck-boost converter and a Cuk converter, a thyristor chopper circuit, an inverter, a rectifier, and a transformer.

10. The power adapter device of claim 1, wherein at least one of the following is true:
the conversion device is implemented using at least one solid-state, monolithic field-effect transistor (FET) device; and
the conversion device includes the cross-point switch, which operates by switching taps on a transformer; and
the conversion device includes at least one large-scale bucket brigade device (BBD) to move charges to an output terminal of the at least one terminal.

11. The power adapter device of claim 1, wherein the conversion device includes at least one large-scale bucket brigade device (BBD), and at least one of the following is true:
the output power includes an output voltage and an output current that can be adjusted by a frequency and an amount of charge injected into a first bucket of the BBD, whereby the conversion device operates as a charge coupled device (CCD);
taps on the BBD allow for picking off varying voltages from the BBD;
the power adapter device is capable of sinking power for cycling batteries; and
the conversion device also includes a plurality of BBDs integrated on a single monolithic device, which are capable of providing the first output power to a first output terminal and a plurality of additional output powers respectively to a plurality of additional output terminals.

12. The power adapter device of claim 1,
wherein the at least one terminal includes a plurality of terminals, each of which is coupled to the conversion device,
wherein each of the plurality of terminals is capable of being variably operated as a port at which power is input, a port at which power is output, a port at which communication signals are input, and a port at which communication signals are output, and
wherein the power adapter device is further capable of operating as a communications router.

13. The power adapter device of claim 1, wherein at least one of the following is true:
the input power is AC power, the input power characteristic is that the AC power is 120 Volts AC, the output power also is AC power, and the output power characteristic is a voltage level of less than 120 Volts AC; and
the input power is DC power, the output power is AC power that is created from the DC power by the conversion device, which chops the DC power to create the AC power.

14. The power adapter device of claim 1, wherein the processing device includes a microprocessor that is coupled to the output terminal by way of at least one of a magnetic coupling device, a filter, and a codec device.

15. The power adapter device of claim 1, wherein the at least one terminal includes an input terminal that is configured to be coupled to at least one of a standard wall socket and an automotive electrical outlet.

16. A power adaptive device for use in relation to low-power devices, the power adaptive device comprising:
a terminal having a plurality of ports;
a control device; and
a conversion device coupled to the terminal and to the control device,
wherein the conversion device in at least some operational circumstances causes a plurality of different power types to be available for output at the plurality of ports, respectively.

17. The power adaptive device of claim 16, wherein the conversion device includes a cross-point switch and a multiple-output voltage regulator, wherein a plurality of voltages are provided from the voltage regulator to the cross-point switch by way of a plurality of voltage lines, wherein the cross-point switch includes a plurality of output lines coupled to the plurality of ports, respectively, and wherein the cross-point switch selectively couples the voltage lines and the output lines based upon commands from the control device.

18. The power adaptive device of claim 16, wherein information regarding power being provided along the output lines is communicated to the control device via transformer pickoffs, and wherein the power adaptive device is capable of simultaneously receiving input power at one of the ports and providing output power at another of the ports.

19. The power adaptive device of claim 16, wherein the terminal is physically configured to receive a complementary plug of an external device, wherein relative configurations of the complementary plug and the terminal determine which of the plurality of different power types is supplied to the external device.

20. A power delivery system comprising:
a first power adapter device including
a terminal capable of providing an output power;
a variable conversion device coupled at least indirectly to the terminal; and
a control device coupled to the conversion device; and
a load device capable of receiving the output power;
wherein the type of output power provided to the load device depends upon at least one of an operational status of the variable conversion device based at least in part upon an informational signal received by the control device, and a physical configuration of at least one of the terminal and a corresponding connection element of the load device.

21. The power delivery system of claim 20, wherein the load device includes an additional control device that provides the informational signal to the control device of the variable conversion device, wherein the load device includes a voltage regulator/filter to regulate power that is received from the terminal, and wherein the variable conversion device provides power at the terminal that is fed from switched taps on a transformer within the variable conversion device.

22. The power delivery system of claim 20, wherein the informational signal is provided over a connection link over which is also provided the output power to the load device.

23. The power delivery system of claim 22, wherein the type of the output power is selected from a plurality of different types of output power having different power characteristics and a plurality of different types of output power having different power levels.

24. The power delivery system of claim 20, wherein the power adaptive device is further capable of at least one of:
general data packet switching and communications with the first load device; and
retaining quiescent power to power up at least one control device within the power adapter device.

25. The power delivery system of claim 20, wherein the variable conversion device includes a cross-point switch, wherein a plurality of output powers having a plurality of output voltage levels are provided at a plurality of ports of the terminal, wherein the connection element includes a special plug, and wherein respective shapes of the special plug and the terminal determine which of the output powers and corresponding output voltage levels are electrically coupled to the load device via the connection element.

26. The power delivery system of claim 20, further comprising a power source device including at least one of an additional power delivery system, an energy storage device, and a power generator,
wherein at least one of the terminal and an additional terminal is capable of receiving an input power from the power source device, and
wherein the load device in at least some embodiments is a further energy storage device.

27. The power delivery system of claim 18, further comprising at least one of:
a second power adapter device having a second output terminal, wherein the second output terminal is coupled to a first input terminal of the first power adapter device; and
a second load device coupled to an additional output terminal of the first power adapter device.

28. A power delivery system comprising:
a power adapter device including
a terminal capable of receiving an input power;
a variable conversion device coupled at least indirectly to the terminal; and
a control device coupled to the conversion device; and
a source device capable of providing the input power;
wherein at least one of the following is true:
an operational status of the power adapter device is determined based upon an informational signal received by the control device; and
a type of the input power received by the terminal is determined at least in part by a physical configuration of at least one of the terminal and a corresponding connection element of the source device.

29. The power delivery system of claim 28, wherein in response to receiving the input power the power delivery system supplies an output power of a different type than the input power to a load device, wherein the source device is capable of providing the informational signal to the power adapter device by way of at least one of the input terminal and a further terminal, and wherein an operation of the variable conversion device in providing the output power is determined at least in part in response to the informational signal.

30. A power system comprising:
a plurality of power source devices respectively providing a plurality of different types of input powers;
a plurality of load devices respectively receiving a plurality of different types of output powers;
a power adapter device coupled to at least four of the power source devices and the load devices, including at least two of the power source devices and at least two of the load devices,
wherein the power adapter device includes means for converting among the powers that are provided and received by the at least four devices.

31. A method of supplying power, comprising:
providing a power adapter device having a variable conversion device;
connecting an input port of the power adapter device to a first power supply;
coupling an output port of the power adapter device to a load;
receiving at least one informational signal from the load indicative of a power requirement of the load; and
adjusting an operational status of the variable conversion device so as to provide, based upon an input power received from the first power supply, an output power of a type satisfying the power requirement.

32. The method of claim 31, further comprising:
decoupling the input port of the power adapter device from the power supply;
coupling the input port to an alternative power adapter device;
further adjusting the operational status of the variable conversion device so as to provide the output power of the type satisfying the power requirement.
